(19) United States
(12) Patent Application Publication
(10) Pub. No.: US 2023/0114695 A1
(43) Pub. Date: Apr. 13, 2023

(54) VACUUM PUMP AND VACUUM PUMP COMPONENT

(71) Applicant: Edwards Japan Limited, Chiba (JP)

(72) Inventors: Kenya Nagase, Chiba (JP); Haruki Suzuki, Chiba (JP); Yongwei Shi, Chiba (JP)

(21) Appl. No.: 17/906,129

(22) PCT Filed: Mar. 11, 2021
(86) PCT No.: PCT/JP2021/009920

§ 371 Date: Sep. 12, 2022

(30) Foreign Application Priority Data
Mar. 19, 2020 (JP) 2020-049766

(51) Int. Cl. F04D 29/58; F04D 19/04; F04D 25/06

(52) U.S. Cl. CPC F04D 29/584; F04D 19/04; F04D 25/06

(57) ABSTRACT

A vacuum pump and a vacuum pump component are provided that achieve the efficient heat dissipation of the rotor without changing the material or structure of stator blades or rotor blades. The vacuum pump includes a casing having a gas inlet port and a gas outlet port and a rotor configured to rotate in the casing. The vacuum pump is configured to exhaust gas from the gas inlet port to the gas outlet port by rotation of the rotor. The rotor substantially has the shape of a cylinder. A purge gas flows between the inner circumference surface of the rotor and the stator column that faces at least a part of the inner circumference surface of the rotor. A projection or a groove that disturbs the flow of the purge gas is provided in the flow passage of the purge gas.

### CROSS-REFERENCE OF RELATED APPLICATION

This application is a Section 371 National Stage Application of International Application No. PCT/JP2021/009920, filed Mar. 11, 2021, which is incorporated by reference in its entirety and published as WO 2021/187336A1 on Sep. 23, 2021 and which claims priority of Japanese Application No. 2020-049766, filed Mar. 19, 2020.

### BACKGROUND

The present invention relates to a vacuum pump used as a gas exhaust means for a process chamber or other enclosed chamber in a manufacturing apparatus, such as a semiconductor manufacturing apparatus, a flat panel display manufacturing apparatus, or a solar panel manufacturing apparatus, and a vacuum pump component.

A conventional vacuum pump is known that applies kinetic energy to gas molecules to compress the gas and discharges the sucked gas through the outlet port. The vacuum pump includes a plurality of stator blades coupled to the housing inner wall, a rotor having a plurality of rotor blades facing the stator blades, and a fixed portion (stator column) facing the inner circumference surface of the rotor with a predetermined gap formed in between. The rotor blades rotate at high speed to draw in and exhaust gas.

The vacuum pump described above is also proposed to be combined with a thread groove pump provided downstream of the vacuum pump.

When a vacuum pump of this type is used in the manufacturing of semiconductors, a process gas that easily solidifies is used as a result of the recent development of semiconductor fabrication technology. As such, the thread groove pump needs to be heated to a high temperature to prevent the accumulation of products.

By contrast, the rotor blades of the rotor tend to be hot due to the collision heat of gas molecules and the like, and the heat thus generated in the rotor portion needs to be appropriately dissipated.

As a technique for dissipating the heat generated in the rotor portion, a method is commonly known that receives the radiant heat from the surfaces of the rotor blades with the stator blades and dissipates the heat to the outside through the stator blade spacers and the casing. Japanese Patent Application Publication No. 2004-278500 describes an example of the technique that uses a molecular pump.

The molecular pump described in the Japanese Patent Application Publication No. 2004-278500 has plate-shaped fins 51 extending in the gas flow passage from the surfaces of the stationary blades 32 in the regions that face the rotor portion and the gas flow passage on the downstream side of the uppermost rotor blade. These fins 51 increase the surface areas of the stationary blades 32, facilitating the reception of the radiant heat from the surfaces of the rotor blades. The fins 51 also reduce the number of gas molecules passing through the stator blade portion 22, and increase the number of gas molecules that collide with the stationary blades 32 and thus are cooled. This improves the cooling efficiency of the rotor blades 21.

However, the molecular pump described in the Japanese Patent Application Publication No. 2004-278500 requires a modification of a structure, such as forming plate-shaped fins on the surfaces of the stationary blades.

Japanese Patent Application Publication No. 2003-184785 discloses a vacuum pump in which an inert gas flows between the inner circumference surface of the rotor and the stator column, which faces the inner circumference surface of the rotor.

The vacuum pump of the Japanese Patent Application Publication No. 2003-184785 does not require a modification of the structure of the stationary blades or the material or structure of the rotor blades, for example. However, with this vacuum pump, the flow of inert gas between the inner circumference surface of the rotor and the stator column is laminar, so that the efficient heat dissipation of the rotor through the convective heat transfer of the inert gas cannot be achieved.

The discussion above is merely provided for general background information and is not intended to be used as an aid in determining the scope of the claimed subject matter. The claimed subject matter is not limited to implementations that solve any or all disadvantages noted in the background.

### SUMMARY

To solve the above problems, it is an objective of the present invention to provide a vacuum pump and a vacuum pump component that achieve the efficient heat dissipation of the rotor without changing the material or structure of stator blades or rotor blades.

To achieve the above objective, the invention according to claim 1 provides a vacuum pump including a casing having an inlet port and an outlet port and a rotor configured to rotate in the casing, the vacuum pump being configured to exhaust gas from the inlet port to the outlet port by rotation of the rotor, wherein the rotor substantially has a shape of a cylinder, an inert gas flows between an inner circumference surface of the rotor and a fixed portion facing at least a part of the inner circumference surface of the rotor, and a flow-disturbing portion is provided in a flow passage of the inert gas to disturb a flow of the inert gas.

The invention according to claim 2 provides the invention according to claim 1, wherein the flow-disturbing portion includes one or more projecting portions on a circumference surface of the fixed portion or the inner circumference surface of the rotor.

The invention according to claim 3 provides the invention according to claim 2, wherein each projecting portion has a shape of a plate.

The invention according to claim 4 provides the invention according to claim 2 or 3, wherein each projecting portion has a portion that is curved with respect to a direction of the flow of the inert gas.

The invention according to claim 5 provides the invention according to any one of claims 2 to 4, wherein each projecting portion is inclined at a predetermined angle with respect to an axial direction of the circumference surface of the fixed portion or the inner circumference surface of the rotor.

The invention according to claim 6 provides the invention according to any one of claims 2 to 5, wherein the projecting portions are spaced apart from one another in a direction that is inclined at a predetermined angle with respect to an axial direction of the circumference surface of the fixed portion or the inner circumference surface of the rotor.

The invention according to claim 7 provides the invention according to claim 1, wherein the flow-disturbing portion includes one or more recesses in a circumference surface of the fixed portion or the inner circumference surface of the rotor.

The invention according to claim 8 provides the invention according to claim 7, wherein each recess is a groove extending in an axial direction of the circumference surface of the fixed portion or the inner circumference surface of the rotor.

The invention according to claim 9 provides the invention according to claim 7 or 8, wherein each recess is inclined at a predetermined angle with respect to an axial direction of the circumference surface of the fixed portion or the inner circumference surface of the rotor.

The invention according to claim 10 provides the invention according to any one of claims 7 to 9, wherein the recesses are spaced apart from one another in a direction that is inclined at a predetermined angle with respect to an axial direction of the circumference surface of the fixed portion or the inner circumference surface of the rotor.

The invention according to claim 11 provides a vacuum pump component to be used in a vacuum pump, wherein the vacuum pump includes a casing having an inlet port and an outlet port and a rotor configured to rotate in the casing, the vacuum pump is configured to exhaust gas from the inlet port to the outlet port by rotation of the rotor, the rotor substantially has a shape of a cylinder, an inert gas flows between an inner circumference surface of the rotor and a fixed portion facing at least a part of the inner circumference surface of the rotor, a flow-disturbing portion is provided in a flow passage of the inert gas to disturb a flow of the inert gas, the vacuum pump component corresponds to the fixed portion, and a circumference surface facing the inner circumference surface of the rotor includes the flow-disturbing portion configured to disturb the flow of the inert gas.

The invention according to claim 12 provides a vacuum pump component to be used in a vacuum pump, wherein the vacuum pump includes a casing having an inlet port and an outlet port and a rotor configured to rotate in the casing, the vacuum pump is configured to exhaust gas from the inlet port to the outlet port by rotation of the rotor, the rotor substantially has a shape of a cylinder, an inert gas flows between an inner circumference surface of the rotor and a fixed portion facing at least a part of the inner circumference surface of the rotor, a flow-disturbing portion is provided in a flow passage of the inert gas to disturb a flow of the inert gas, the vacuum pump component corresponds to the rotor, and the inner circumference surface facing the fixed portion includes the flow-disturbing portion configured to disturb the flow of the inert gas.

According to the present invention, in a vacuum pump including a casing having an inlet port and an outlet port and a rotor that is configured to rotate in the casing to exhaust gas from the inlet port to the outlet port and substantially has the shape of a cylinder, when an inert gas flows between the inner circumference surface of the rotor and a fixed portion that faces at least a part of the inner circumference surface of the rotor to prevent exhaust gas from entering the fixed portion containing electric components, a flow-disturbing portion provided in a flow passage of the inert gas to disturb the flow of the inert gas achieves the efficient heat dissipation of the rotor without changing the material or structure of rotor blades.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a cross-sectional view of a vacuum pump to which the present invention is applied;

FIG. 2 is a diagram illustrating a flow of an inert gas in the vacuum pump shown in FIG. 1;

FIG. 3 is a diagram showing a first embodiment of a vacuum pump according to the present invention;

FIG. 4 is an enlarged view of a main part of the vacuum pump shown in FIG. 3;

FIGS. 5A to 5C are diagrams showing other examples of a flow-disturbing portion that disturbs the flow of inert gas used in the vacuum pump shown in FIG. 3;

FIG. 6 is an enlarged view of a main part of a second embodiment of a vacuum pump according to the present invention;

FIG. 7 is a diagram showing a third embodiment of a vacuum pump according to the present invention;

FIGS. 8A and 8B are diagrams showing examples of grooves used in the vacuum pump shown in FIG. 7;

FIG. 9 is a diagram showing another example of a flow-disturbing portion that disturbs the flow of inert gas used in the vacuum pump shown in FIG. 7; and

FIG. 10 is an enlarged view of a main part of a fourth embodiment of a vacuum pump according to the present invention.

### DETAILED DESCRIPTION

Referring to the attached drawings, embodiments of the present invention are now described in detail.

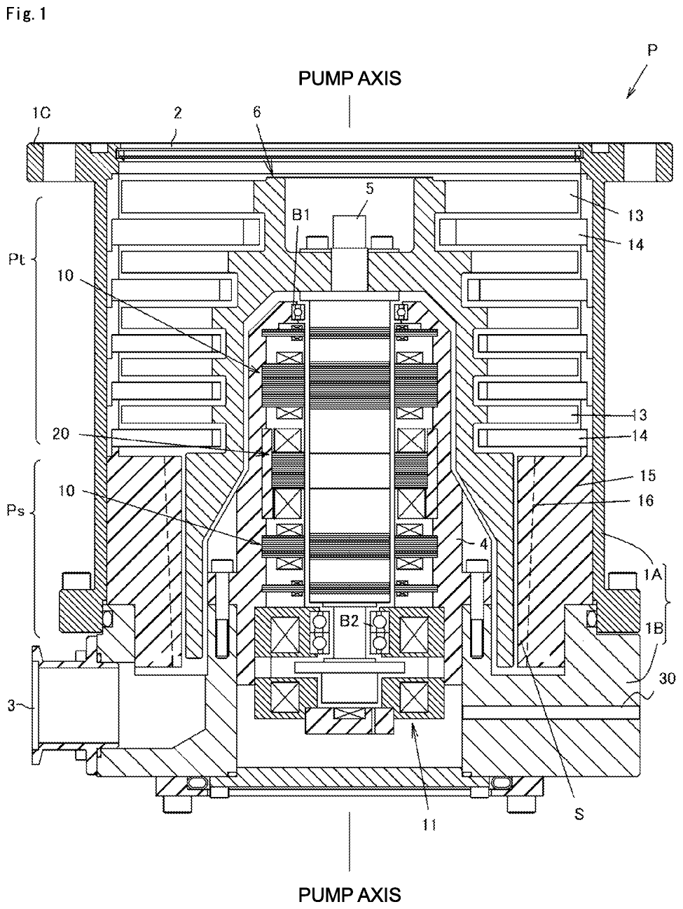

FIG. 1 is a cross-sectional view of a vacuum pump to which the present invention is applied. The vacuum pump P shown in FIG. 1 may be used as a gas exhaust means for a process chamber or other enclosed chamber in a semiconductor manufacturing apparatus, a flat panel display manufacturing apparatus, or a solar panel manufacturing apparatus.

The vacuum pump P includes, in a casing 1, a blade exhaust portion Pt, which uses rotor blades 13 and stator blades 14 to exhaust gas, a thread groove exhaust portion Ps, which uses a thread groove 16 to exhaust gas, and the driving systems of these portions.

The casing 1 has the shape of a cylinder with a closed end and includes a cylindrical pump case 1A and a cylindrical pump base 1B with a closed end, which are coupled together with bolts in the axial direction of the cylinder. The upper end of the pump case 1A opens as a gas inlet port 2, and the lower end of the pump base 1B has a gas outlet port 3.

The gas inlet port 2 is connected to an enclosed chamber (not shown) having a high vacuum, such as a process chamber of a semiconductor manufacturing apparatus, with bolts (not shown) provided on a flange 1C at the upper edge of the pump case 1A. The gas outlet port 3 communicates with an auxiliary pump (not shown).

A cylindrical stator column 4, which contains various electrical components, is provided in the central portion of the pump case 1A. The stator column 4 extends upright with its lower end fixed to the pump base 1B with screws.

A rotor shaft 5, which is provided inside the stator column 4, is oriented such that its upper end faces toward the gas inlet port 2 and its lower end faces toward the pump base 1B. Furthermore, the upper end of the rotor shaft 5 extends upward beyond the upper end surface of the cylindrical stator column 4.

The rotor shaft 5 is rotatably levitated and supported in the radial and axial directions by the magnetic forces of radial magnetic bearings 10 and an axial magnetic bearing 11, and is driven and rotated by a motor 20. Protective bearings B1 and B2 are provided at the upper and lower ends of the rotor shaft 5.

A rotor 6 is provided outward of the stator column 4. The rotor 6 has the shape of a cylinder surrounding the outer circumference of the stator column 4, is integral with the rotor shaft 5, and is configured to rotate in the pump case 1A with the rotor shaft 5 as the rotation axis.

As such, in the vacuum pump P of FIG. 1, the rotor shaft 5, the radial magnetic bearings 10, 10, and the axial magnetic bearing 11 function as a supporting means that supports the rotor 6 so as to be rotatable about its axis. Furthermore, since the rotor 6 rotates integrally with the rotor shaft 5, the motor 20, which drives and rotates the rotor shaft 5, functions as a driving means that drives and rotates the rotor 6.

Since the detailed configurations of the protective bearings B1 and B2, the radial magnetic bearings 10, and the axial magnetic bearing 11 are well known in the art, the descriptions thereof are omitted.

In the vacuum pump P of FIG. 1, the section upstream of the approximate midpoint of the rotor 6 (the range from the approximate midpoint of the rotor 6 to the end of the rotor 6 including the gas inlet port 2) functions as the blade exhaust portion Pt. The detailed configurations of the blade exhaust portion Pt are now described.

The rotor 6 includes a plurality of rotor blades 13 formed integrally with the outer circumference surface of the section of the rotor 6 on the upstream side of the approximate midpoint of the rotor 6. The rotor blades 13 extend from the outer circumference surface of the rotor 6 in the radial direction of the rotor 6. The rotor blades 13 are arranged radially about the rotation axis of the rotor 6 (rotor shaft 5) or the axis of the casing 1 (hereinafter referred to as a “pump axis”). The rotor blades 13 are formed integrally with the outer diameter processing portion of the rotor 6 by a cutting process and inclined at an optimum angle to exhaust gas molecules.

A plurality of stator blades 14 are provided on the inner circumference surface of the pump case 1A. The stator blades 14 extend from the inner circumference surface of the pump case 1A toward the outer circumference surface of the rotor 6 and are arranged radially about the pump axis. As with the rotor blades 13, the stator blades 14 are also inclined at an optimum angle to exhaust gas molecules.

In the vacuum pump P of FIG. 1, the rotor blades 13 and the stator blades 14 described above are alternately arranged in multiple stages along the pump axis, thereby forming the multi-stage blade exhaust portion Pt.

In the blade exhaust portion Pt thus configured, the rotor shaft 5, the rotor 6, and the rotor blades 13 rotate together at high speed when the motor 20 is activated, and the uppermost rotor blade 13 applies a downward momentum to the gas molecules entering through the gas inlet port 2. The gas molecules having this downward momentum are transferred to the rotor blade 13 in the next stage by the stator blade 14. The application of the momentum to the gas molecules and the transfer action are repeated in multiple stages, causing the gas molecules to move sequentially from the gas inlet port 2 to the downstream side of the rotor 6 and be exhausted.

In the vacuum pump P of FIG. 1, the section downstream of the approximate midpoint of the rotor 6 (the range from the approximate midpoint of the rotor 6 to the end of the rotor 6 including the gas outlet port 3) functions as the thread groove exhaust portion (thread groove pump) Ps. The detailed configurations of the thread groove exhaust portion Ps are now described.

The section of the rotor 6 on the downstream side of the approximate midpoint of the rotor 6 is configured to rotate as a rotation member of the thread groove exhaust portion Ps and is placed inward of a thread groove exhaust portion stator 15.

The thread groove exhaust portion stator 15 is a cylindrical fixed member and surrounds the outer circumference of the rotor 6 (the section downstream of the approximate midpoint of the rotor 6). The pump base 1B supports the lower end of the thread groove exhaust portion stator 15.

The inner circumference of the thread groove exhaust portion stator 15 has a thread groove 16, which decreases in depth toward the lower end and thus forms the shape of a cone tapering downward. The thread groove 16 is engraved in the shape of a spiral from the upper end to the lower end of the thread groove exhaust portion stator 15. The thread groove 16 forms a spiral thread groove exhaust passage S between the rotor 6 and the thread groove exhaust portion stator 15. Although not shown, the thread groove exhaust passage S may also be provided by forming the thread groove 16 described above in the outer circumference surface of the rotor 6.

In the thread groove exhaust portion Ps, the drag effect at the thread groove 16 and the outer circumference surface of the rotor 6 transfers the gas while compressing it. To this end, the depth of the thread groove 16 is deepest at the upstream inlet of the thread groove exhaust passage S (the passage open end that is closer to the gas inlet port 2) and shallowest at the downstream outlet (the passage open end that is closer to the gas outlet port 3).

The upstream inlet of the thread groove exhaust passage S communicates with the gap formed downstream of the blade in the lowermost stage (the stator blade 14 in the lowermost stage in the example of FIG. 1) among the rotor blades 13 and the stator blades 14 in multiple stages, whereas the downstream outlet of the thread groove exhaust passage S communicates with the gas outlet port 3.

The gas molecules that have been transferred by the exhaust action of the blade exhaust portion Pt described above and reached the blade in the lowermost stage (the rotor blade 13 in the example of FIG. 1) enter the thread groove exhaust passage S through the upstream inlet of the thread groove exhaust passage S. The effect caused by the rotation of the rotor 6, that is, the drag effect at the outer circumference surface of the rotor 6 and the thread groove 16, compresses the entering gas molecules so that their transitional flow is converted into a viscous flow while moving toward the gas outlet port 3. Eventually, the gas molecules are exhausted to the outside through an auxiliary pump (not shown).

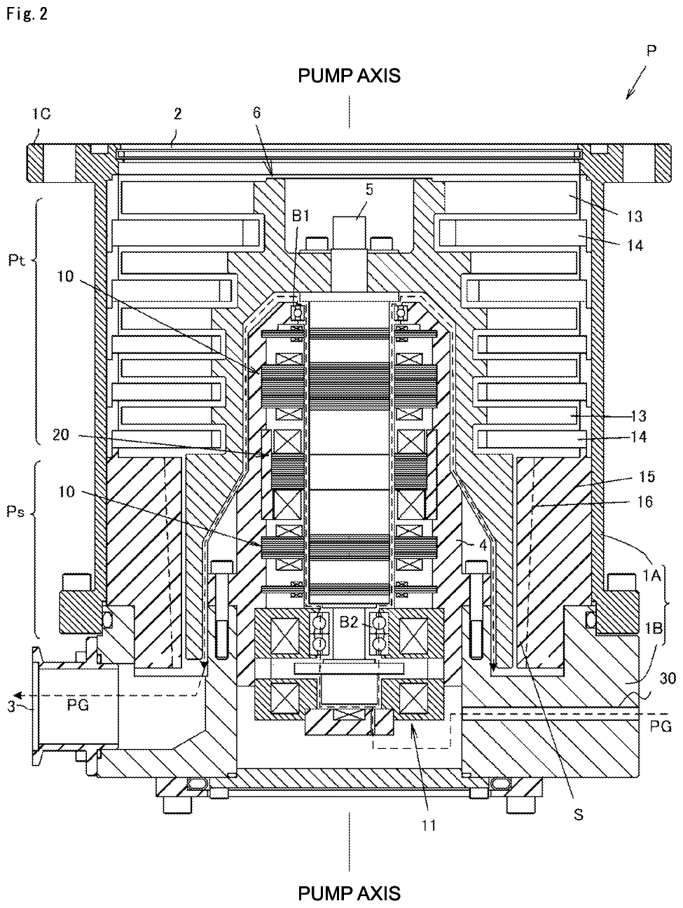

FIG. 2 is a diagram illustrating a flow of inert gas (purge gas) according to the present invention used in the vacuum pump shown in FIG. 1.

As described above, the cylindrical rotor 6 surrounds the outer circumference of the cylindrical stator column 4 containing various electrical components. A purge gas PG is injected into the pump case 1A from the outside through a purge gas injection passage 30, flows through the passage providing communication between the gap between the outer wall of the rotor shaft 5 and the inner wall of the stator column 4 and the gap between the outer wall of the stator column 4 and the inner wall of the rotor 6, and is exhausted from the gas outlet port 3.

The purge gas PG may be a gas having a high thermal conductivity, such as nitrogen gas. The compression heat accumulating in the rotor 6 is dissipated from the inner wall surface of the rotor 6 to the outer wall surface of the stator column 4 via the purge gas PG. The rotor 6 and the rotor blades 13 are thus cooled.

In a conventional configuration, the purge gas PG flowing through the gap between the outer wall of the stator column 4 and the inner wall of the rotor 6 forms a laminar flow. As such, the sufficient cooling effect of the rotor 6 and the rotor blades 13 cannot be achieved even when a gas with a high thermal conductivity such as nitrogen gas is used as the purge gas PG.

In this respect, the vacuum pump of the present invention has a flow-disturbing portion in the flow passage of the purge gas PG to disturb the flow of the purge gas PG. The flow-disturbing portion converts the flow of the purge gas PG from a laminar flow into a turbulent flow as much as possible to improve the cooling effect for the rotor 6 and the rotor blades 13.

Various embodiments of a vacuum pump of the present invention are now described in detail.

### First Embodiment

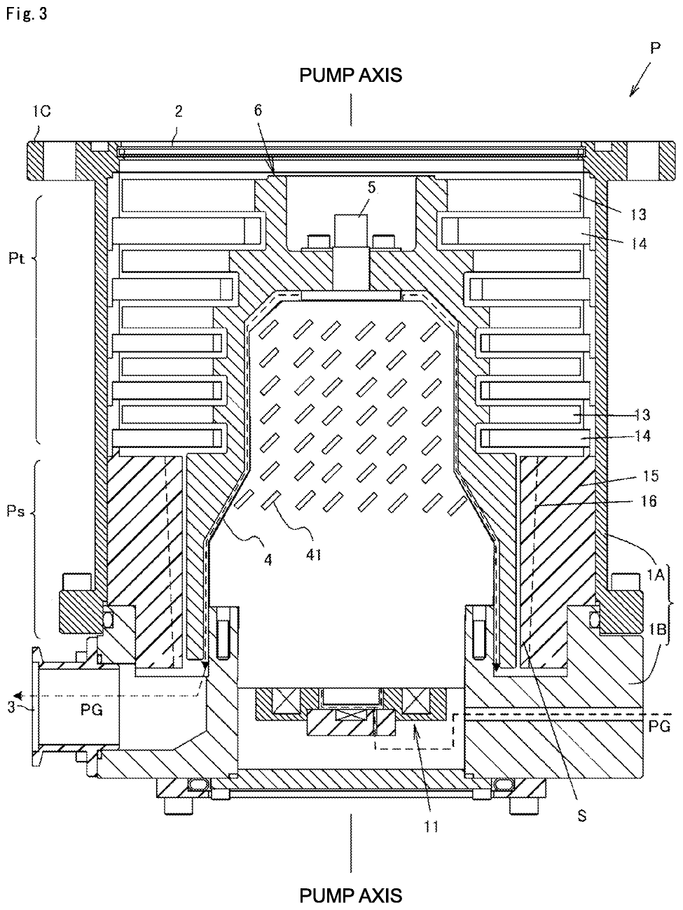

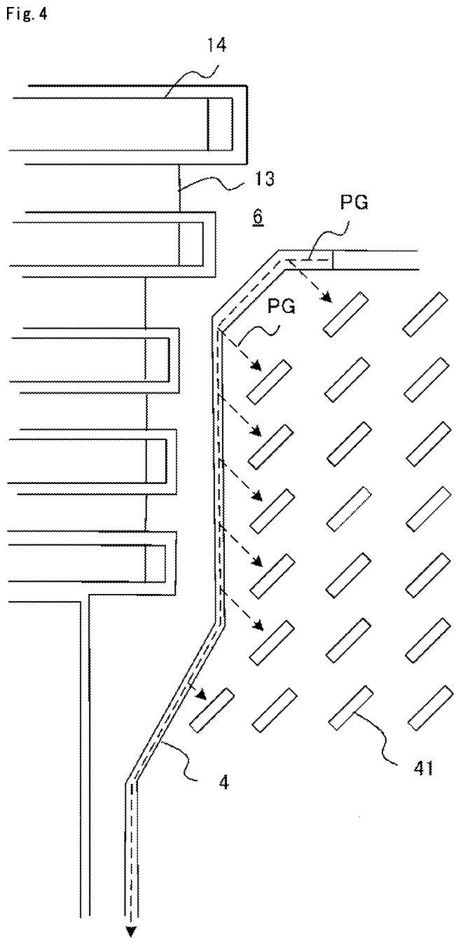

FIG. 3 is a diagram showing an embodiment of a vacuum pump according to the present invention, and FIG. 4 is an enlarged view of a main part of the vacuum pump shown in FIG. 3. The vacuum pump of the first embodiment shown in FIGS. 3 and 4 includes a plurality of projections 41 on the outer circumference surface (circumference surface) of the stator column 4. Other configurations are the same as those described with reference to FIGS. 1 and 2.

In this configuration, the purge gas PG flowing through the gap between the outer wall of the stator column 4 and the inner wall of the rotor 6 collides with the projections 41, so that its flow is disturbed. As a result, the flow of purge gas through the gap between the outer wall of the stator column 4 and the inner wall of the rotor 6 is converted from a laminar flow into a turbulent flow or a flow that resembles a turbulent flow. Even when the flow that has been converted into a flow resembling a turbulent flow by projections 41 on the upstream side is converted again into a laminar flow on the downstream side, other projections 41 can again convert this flow into a flow resembling a turbulent flow. That is, providing the plurality of projections 41 advantageously forms a flow resembling a turbulent flow in a large area.

When the flow of purge gas PG through the gap between the outer wall of the stator column 4 and the inner wall of the rotor 6 is converted into a turbulent flow or a flow resembling a turbulent flow, the convective heat transfer by the purge gas PG is significantly improved, achieving the efficient heat dissipation of the rotor without changing the material or structure of stator blades or rotor blades.

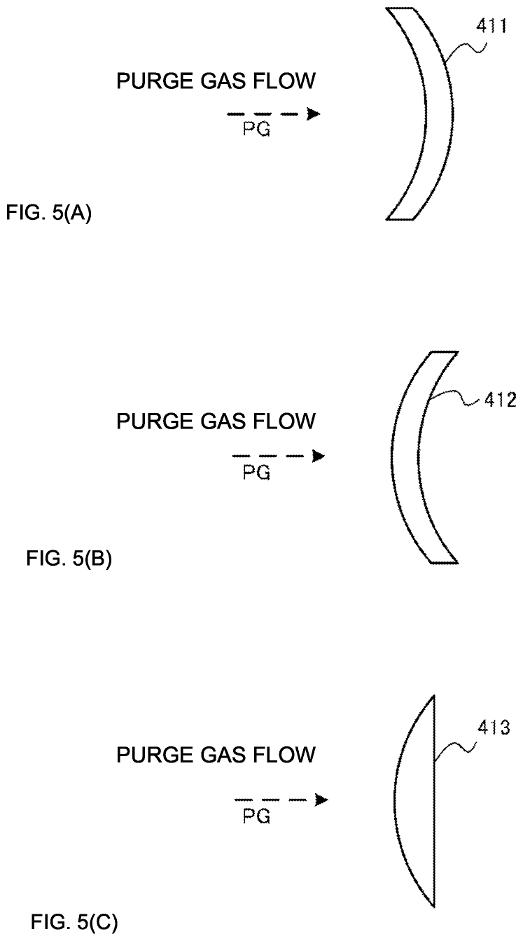

The example shown in FIGS. 3 and 4 uses the projection 41 that is a plate having the shape of a rectangular solid. However, instead of this projection 41, a projection 411 that is a plate having a bowl-shaped cross-section recessed in the flow direction of the purge gas PG shown in FIG. 5A, a projection 412 that is a plate having an inverted bowl-shaped cross-section bulging in the flow direction of the purge gas PG shown in FIG. 5B, or a projection 413 that is a plate having a bow-shaped cross-section bulging in the flow direction of the purge gas PG shown in FIG. 5C may be used to form a similar configuration.

The embodiment shown in FIGS. 3 and 4 includes a plurality of projections 41. However, forming only one projection 41 can still disturb the flow of the purge gas PG to some extent, improving the convective heat transfer by the purge gas PG.

### Second Embodiment

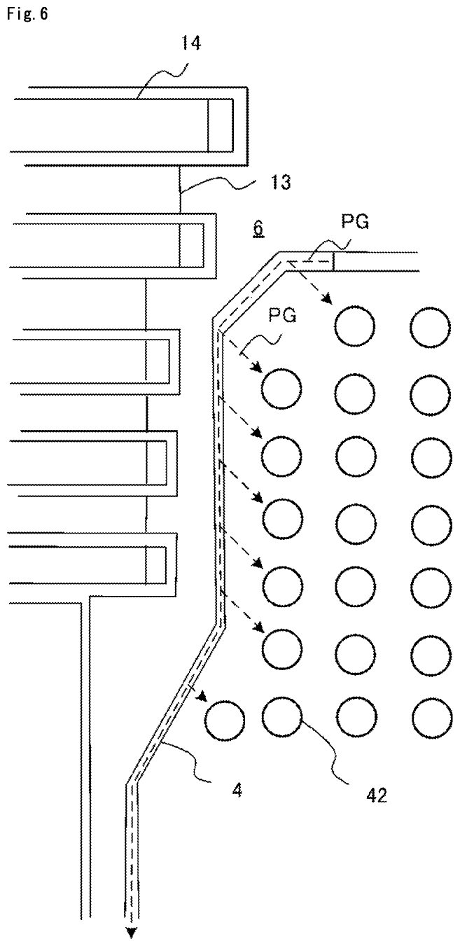

FIG. 6 is an enlarged view of a main part of a second embodiment of a vacuum pump according to the present invention and corresponds to the enlarged view of the main part of the vacuum pump of FIG. 4.

The second embodiment shown in FIG. 6 includes hemispherical protrusions 42, in place of the projections 41 shown in FIG. 4. In the vacuum pump of the second embodiment shown in FIG. 6, the purge gas PG flowing through the gap between the outer wall of the stator column 4 and the inner wall of the rotor 6 collides with these hemispherical protrusions 42, so that its flow is disturbed. As a result, the flow of purge gas through the gap between the outer wall of the stator column 4 and the inner wall of the rotor 6 is converted from a laminar flow into a turbulent flow or a flow that resembles a turbulent flow.

Accordingly, in the vacuum pump of the second embodiment, the convective heat transfer by the purge gas PG flowing through the gap between the outer wall of the stator column 4 and the inner wall of the rotor 6 is also significantly improved, achieving the efficient heat dissipation of the rotor without changing the material or structure of stator blades or rotor blades.

### Third Embodiment

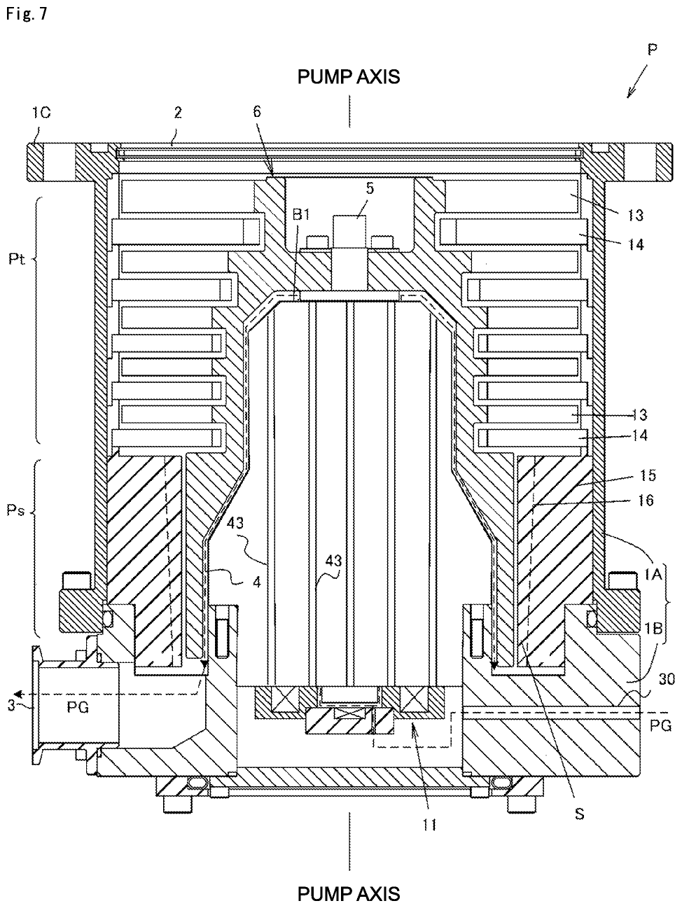

FIG. 7 is a diagram showing a third embodiment of a vacuum pump according to the present invention.

The vacuum pump of the third embodiment shown in FIG. 7 includes a plurality of grooves 43 formed in the outer circumference surface (circumference surface) of the stator column 4. Other configurations are the same as those described with reference to FIGS. 1 and 2.

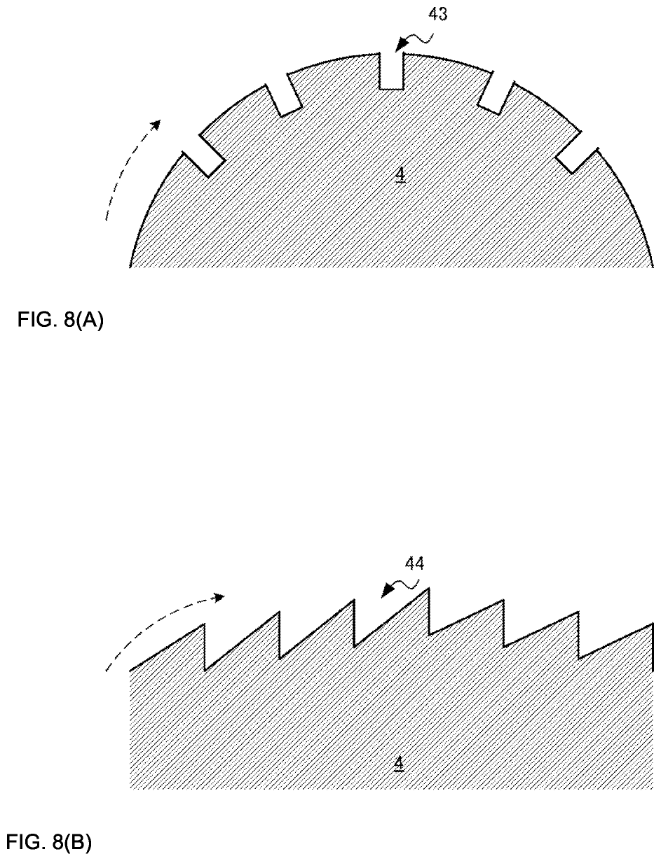

FIG. 8A is a cross-sectional view of the stator column 4 showing the shape of the grooves 43 shown in FIG. 7. As shown in FIG. 8A, each groove 43 has a rectangular shape as viewed in a cross-section perpendicular to the axis of the stator column 4. These grooves 43 also disturb the flow of purge gas through the gap between the outer wall of the stator column 4 and the inner wall of the rotor 6, thereby converting the flow from a laminar flow into a turbulent flow or a flow resembling a turbulent flow. Accordingly, the convective heat transfer by the purge gas PG flowing through the gap between the outer wall of the stator column 4 and the inner wall of the rotor 6 is also significantly improved, achieving the efficient heat dissipation of the rotor without changing the material or structure of stator blades or rotor blades.

The direction of purge gas flow at a predetermined angle results from the relationship between the velocity component in the axial direction of the stator column 4, which depends on the difference in pressure between the upstream side and the downstream side, and the velocity component in the tangential direction of rotation caused by the fluid drag effect at the inner circumference surface of the rotor 6.

The grooves 43 shown in FIG. 7 may form a sawtooth shape like the grooves 44 shown in FIG. 8B. The grooves 44 form a sawtooth shape including inclined sections rising in the flow direction of inert gas as viewed in a cross-section perpendicular to the axis of the stator column 4. These grooves 44 forming a sawtooth shape also disturb the flow of purge gas through the gap between the outer wall of the stator column 4 and the inner wall of the rotor 6, thereby converting the flow from a laminar flow into a turbulent flow or a flow resembling a turbulent flow. Accordingly, the convective heat transfer by the purge gas PG flowing through the gap between the outer wall of the stator column 4 and the inner wall of the rotor 6 is also significantly improved, achieving the efficient heat dissipation of the rotor without changing the material or structure of stator blades or rotor blades.

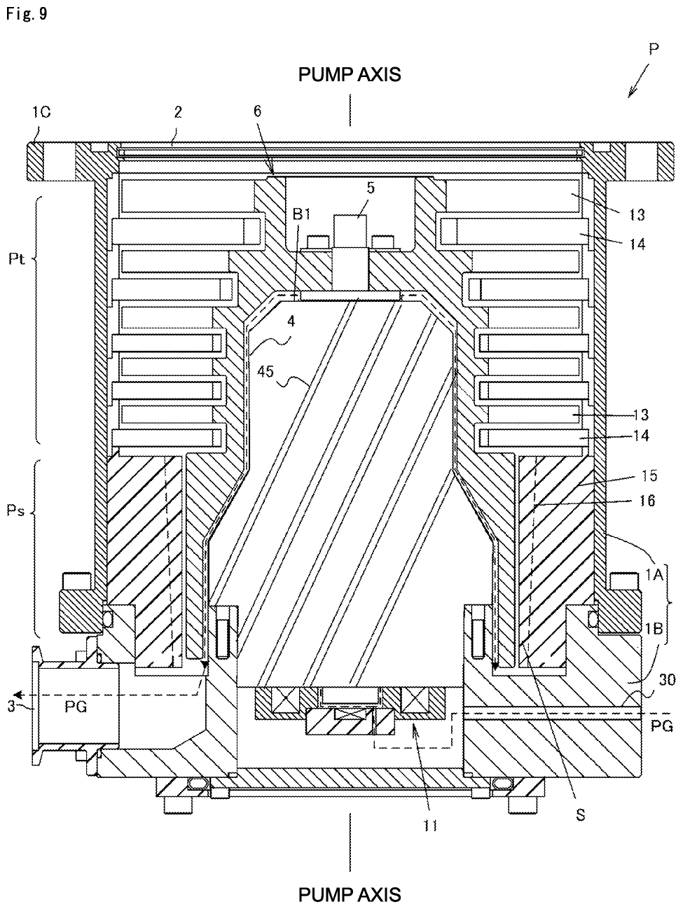

In the third embodiment shown in FIG. 7, the grooves 43 extend in the axial direction of the stator column 4. However, as shown in FIG. 9, the circumference surface of the stator column 4 may include grooves 45 that extend in a direction that disturbs the flow of purge gas PG and is inclined at a predetermined angle with respect to the axial direction of the stator column 4. The grooves 45 disturb the flow of purge gas through the gap between the outer wall of the stator column 4 and the inner wall of the rotor 6, thereby converting the flow from a laminar flow into a turbulent flow or a flow resembling a turbulent flow. This significantly improves the convective heat transfer by the purge gas PG flowing through the gap between the outer wall of the stator column 4 and the inner wall of the rotor 6, achieving the efficient heat dissipation of the rotor without changing the material or structure of stator blades or rotor blades.

The grooves 45 may be shaped such that each groove has a rectangular shape as viewed in a cross-section perpendicular to the axis of the stator column 4 as shown in FIG. 8A, or such that the grooves form a sawtooth shape including inclined sections rising in the flow direction of inert gas as viewed in a cross-section perpendicular to the axis of the stator column 4 as shown in FIG. 8B.

### Fourth Embodiment

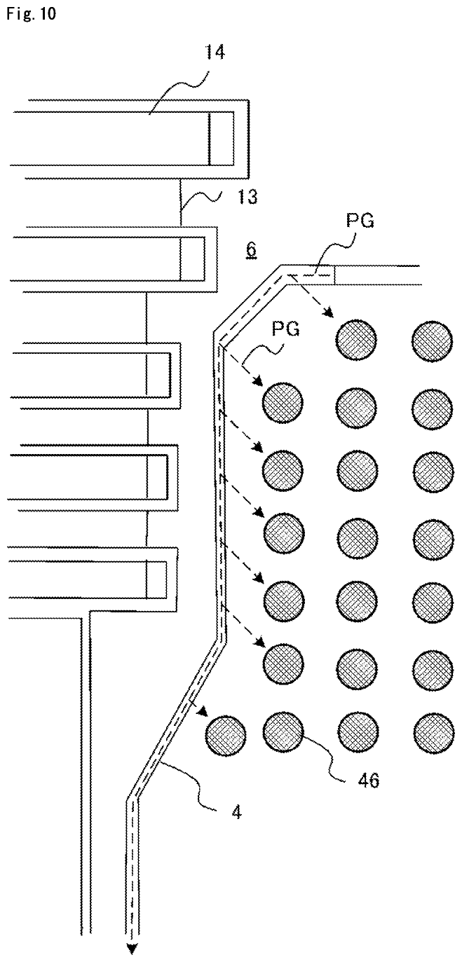

FIG. 10 is an enlarged view of a main part of a fourth embodiment of a vacuum pump according to the present invention and corresponds to the enlarged view of the main part of the vacuum pump of FIG. 6.

The vacuum pump shown in FIG. 6 includes a plurality of hemispherical protrusions 42 formed on the surface of the stator column 4. In contrast, the fourth embodiment shown in FIG. 10 includes a plurality of hemispherical recesses 46 in the surface of the stator column 4. Other configurations are the same as those described with reference to FIG. 6.

In this configuration including the hemispherical recesses 46 in the surface of the stator column 4, the flow of purge gas through the gap between the outer wall of the stator column 4 and the inner wall of the rotor 6 is also disturbed and thus converted from a laminar flow into a turbulent flow or a flow resembling a turbulent flow. This significantly improves the convective heat transfer by the purge gas PG flowing through the gap between the outer wall of the stator column 4 and the inner wall of the rotor 6, achieving the efficient heat dissipation of the rotor without changing the material or structure of stator blades or rotor blades.

In the embodiments described above, the flow-disturbing portion that disturbs the flow of the purge gas PG includes the projections 41, 411, 412, 413, the protrusions 42, the grooves 43, 44, 45, or the recesses 46 formed on or in the circumference surface of the stator column 4. However, the flow-disturbing portion that disturbs the flow of the purge gas PG may be formed on or in the inner wall of the rotor 6 corresponding to the projections 41, 411, 412, 413, the protrusions 42, the grooves 43, 44, 45, or the recesses 46.

In this configuration, the flow of purge gas through the gap between the outer wall of the stator column 4 and the inner wall of the rotor 6 is also disturbed and thus converted from a laminar flow into a turbulent flow or a flow resembling a turbulent flow. This significantly improves the convective heat transfer by the purge gas PG flowing through the gap between the outer wall of the stator column 4 and the inner wall of the rotor 6, achieving the efficient heat dissipation of the rotor without changing the material or structure of stator blades or rotor blades.

In the above embodiment, as the flow-disturbing portion that disturbs the flow of the purge gas PG, a plurality of projections or grooves are formed on or in the surface of the stator column 4 or the inner circumference surface of the rotor 6. Alternatively, the surface of the stator column 4 or the inner circumference surface of the rotor 6 may be roughened by surface treatment or the like so as to disturb the flow of the purge gas PG.

Furthermore, the flow-disturbing portion provided on the surface of the stator column 4 or the inner circumference surface of the rotor 6 may have any shape as long as it disturbs the flow of the purge gas PG, and the number thereof and the region in which the flow-disturbing portion is formed may be modified in various manners.

It should be noted that the present invention is not limited to the above-described embodiments, and various modifications can be made by the ordinary creative ability of those skilled in the art within the scope of the technical idea of the present invention.

Although elements have been shown or described as separate embodiments above, portions of each embodiment may be combined with all or part of other embodiments described above. Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump comprising a casing having an inlet port and an outlet port and a rotor configured to rotate in the casing, the vacuum pump being configured to exhaust gas from the inlet port to the outlet port by rotation of the rotor, wherein
the rotor substantially has a shape of a cylinder,
an inert gas flows between an inner circumference surface of the rotor and a fixed portion facing at least a part of the inner surface of the rotor, and
a flow-disturbing portion is provided in a flow passage of the inert gas to disturb a flow of the inert gas.

2. The vacuum pump according to claim 1, wherein the flow-disturbing portion includes one or more projecting portions on a circumference surface of the fixed portion or the inner circumference surface of the rotor.

3. The vacuum pump according to claim 2, wherein each of the projecting portions has a shape of a plate.

4. The vacuum pump according to claim 2, wherein each of the projecting portions has a portion that is curved with respect to a direction of the flow of the inert gas.

5. The vacuum pump according to claim 2, wherein each of the projecting portions is inclined at a predetermined angle with respect to an axial direction of the circumference surface of the fixed portion or the inner circumference surface of the rotor.

6. The vacuum pump according to claim 2, wherein the projecting portions are spaced apart from one another in a direction that is inclined at a predetermined angle with respect to an axial direction of the circumference surface of the fixed portion or the inner circumference surface of the rotor.

7. The vacuum pump according to claim 1, wherein the flow-disturbing portion includes one or more recesses in a circumference surface of the fixed portion or the inner circumference surface of the rotor.

8. The vacuum pump according to claim 7, wherein each of the recesses is a groove extending in an axial direction of the circumference surface of the fixed portion or the inner circumference surface of the rotor.

9. The vacuum pump according to claim 7, wherein each of the recesses is inclined at a predetermined angle with respect to an axial direction of the circumference surface of the fixed portion or the inner circumference surface of the rotor.

10. The vacuum pump according to claim 7, wherein the recesses are spaced apart from one another in a direction that is inclined at a predetermined angle with respect to an axial direction of the circumference surface of the fixed portion or the inner circumference surface of the rotor.

11. A vacuum pump component to be used in a vacuum pump, wherein the vacuum pump includes a casing having an inlet port and an outlet port and a rotor configured to rotate in the casing, the vacuum pump is configured to exhaust gas from the inlet port to the outlet port by rotation of the rotor, the rotor substantially has a shape of a cylinder, an inert gas flows between an inner circumference surface of the rotor and a fixed portion facing at least a part of the inner circumference surface of the rotor, a flow-disturbing portion is provided in a flow passage of the inert gas to disturb a flow of the inert gas,
the vacuum pump component corresponds to the fixed portion, and
a circumference surface facing the inner circumference surface of the rotor includes the flow-disturbing portion configured to disturb the flow of the inert gas.

12. A vacuum pump component to be used in a vacuum pump, wherein the vacuum pump includes a casing having an inlet port and an outlet port and a rotor configured to rotate in the casing, the vacuum pump is configured to exhaust gas from the inlet port to the outlet port by rotation of the rotor, the rotor substantially has a shape of a cylinder, an inert gas flows between an inner circumference surface of the rotor and a fixed portion facing at least a part of the inner circumference surface of the rotor, a flow-disturbing portion is provided in a flow passage of the inert gas to disturb a flow of the inert gas,
the vacuum pump component corresponds to the rotor, and
the inner circumference surface facing the fixed portion includes the flow-disturbing
